(19) United States
(12) Patent Application Publication
(10) Pub. No.: US 2005/0214190 A1
(43) Pub. Date: Sep. 29, 2005

(54) Method of synthesizing nanorods by reaction of metal-surfactant complexes injected using a syringe pump

(75) Inventors: Taeghwan Hyeon, Seoul (KR); Jongnam Park, Seoul (KR)

Correspondence Address: MARGER JOHNSON & MCCOLLOM, P.C., 210 SW MORRISON STREET, SUITE 400, PORTLAND, OR, 97204, US

(73) Assignee: SEOUL NATIONAL UNIVERSITY, Seoul (KR)

(21) Appl. No.: 10/811,504

(22) Filed: Mar. 25, 2004

(51) Int. Cl. C01B 25/08

(52) U.S. Cl. 423/299; 423/622

(57) ABSTRACT

Synthetic methods for producing uniform in diameter and highly crystalline nanorods of metals, alloys, metal oxides, metal nitrides, metal pnictides or metal chalcogenides by reaction of metal-surfactant complexes injected at a constant injection rate using a syringe pump into a surfactant solution in order to induce the one-dimensional growth of the nanostructured materials, where the reaction includes thermal decomposition, reduction, oxidation, sulfidation and phosphidation, are disclosed. The steps of a typical synthetic method consist of forming metal-surfactant complexes from the reaction of metal precursors and surfactant, injecting said metal-surfactant complex into a solution containing a surfactant and a reagent at high temperature using a syringe pump at a constant injection rate, aging at high temperature, and separating as well as precipitating by adding a poor solvent, and finally retrieving the desired nanorods by centrifuging.

### TECHNICAL FIELD

The present invention relates to a method of synthesizing uniform nanorods of metals, alloys, metal oxides, metal nitrides, metal pnictides, or metal chalcogenides by reaction of metal-surfactant complexes injected using a syringe pump, where the reaction includes thermal decomposition, reduction, oxidation, sulfidation and phosphidation,

### BACKGROUND ART

One-dimensional (1-D) nanostructured materials including nanorods, nanowires and nanotubes have been receiving a great deal of attention recently primarily due to their unique properties of low dimensionality and possibly quantum confinement effect [Xia, Y. et al., “One-dimensional Nanostructures: Synthesis, Characterization and Applications”, Adv. Mater. 2003, 15, 353]. These 1-D nanostructured materials found their way to be used for wide applications in interconnections and functional blocks for fabricating electronic, magnetic and optical devices in nanoscale. In the past several years, a variety of chemical methods have been used in demonstrating methods of synthesizing many types of nanorods. These synthetic methods are typically anisotropic growth with the intrinsic anisotropic crystal structure in a solid material, anisotropic growth using tubular templates, and anisotropic growth kinetically controlled by super-saturation or by using an appropriate capping surfactant. The synthesis of nanostructured magnetic materials is a very important area of research because of their potentially practical applications in the areas of magnetic storage devices at the density level of multi-terabit/in² and also of the use of magnetic carriers for drug targeting, particularly, for cancer treatment purposes.

There have been several reports on the synthesis of discrete 1-D magnetic nanorods.

Park, S. L. et al. reported on the synthesis of iron nanorods by using the process of oriented attachment of monodisperse spherical nanoparticles [Park, S. J. et al., “Synthesis and Magnetic Studies of Uniform Iron Nanorods and Nanospheres”, J. Am. Chem. Soc. 2000, 122, 8581]. Puntes, V. F. et al. reported on the synthesis of cobalt nanodisks by means of thermal decomposition of the cobalt carbonyl precursors [Puntes, V. F. et al., “Colloidal Nanocrystal Shape and Size Control: The Case of Cobalt”, Science 2001, 291, 2115]. Dumestre, F., et al. reported on the synthesis of cobalt nanorods [Dumestre, F. et al., “Shape Control of Thermodynamically Stable Cobalt Nanorods through Organometallic Chemistry,” Angew, Chem. Int. Ed. 2002, 41, 4286], and Cordente, N. et al. reported on the synthesis of nickel nanorods by means of high-temperature reduction of organometallic complexes [Cordente, N. et al., “Synthesis and Magnetic Properties of Nickel Nanorods”, Nano Lett., 2001, 1, 565.].

However, most of the synthesis methods aforementioned deal with nanorods with diameter larger than 20 nm, and also the methods of synthesizing nanorods with diameter ranging from 2 nm to 20 nm. Furthermore, the case where the diameter of the nanorods is uniform and, in particular, the diameter-controlled synthesis method of nanorods with diameter less than 20 nm have not been reported. This is primarily due to the complexity of the necessary synthesis procedures and also due to very low reproducibility of the nanorods of uniform in size.

Hyeon, T. et al. [Hyeon, T., “Chemical Synthesis of Magnetic Nanoparticles”, Chem. Comm., 2003, 927; and also Hyeon, T. et al., “Synthesis of Highly Crystalline and Monodisperse Maghemite Nanocrystallites without a Size-Selection Process,” J. Am. Chem. Soc. 2001, 123, 12798] and Joo, J. et al. [Joo, J. et al., “Multi-gram Scale Synthesis and Characterization of Monodisperse Tetragonal Zirconia Nanocrystals,” J. Am. Chem. Soc. 2003, 125, 6553.] have previously reported on the methods of synthesizing monodisperse nanocrystals of metals, oxides and sulfides, where a method of thermal decomposition of metal-surfactant complex is employed.

The present invention is a new and novel method of synthesizing desired nanorods, which method is an outgrowth of the work carried out previously by Hyeon, T., et al. aforementioned. The main objective of the present invention is to disclose methods of synthesizing nanorods of metals, alloys, metal oxides, metal nitrides, metal pnictides, or metal chalcogenides having excellent characteristics of uniformity in diameter and crystallinity as previously described elsewhere by reacting continuously injected metal-surfactant complexes using a syringe pump.

### BRIEF DESCRIPTIONS OF THE DRAWINGS

FIG. 1 is a flowchart showing a synthetic procedure of nanorods according to the present invention.

FIG. 1-A-1 is an exemplary TEM (Transmission Electron Microscope) image of iron phosphide (Fe₂P) nanorods of size 5 nm (diameter)×88 nm (length) synthesized according to Embodiment 1-A.

FIG. 1-A-2 is an exemplary HRTEM (High Resolution Transmission Electron Microscope) image of iron phosphide (Fe₂P) nanorods of size 5 nm (diameter)×88 nm (length) synthesized according to Embodiment 1-A.

FIG. 1-A-3 is an exemplary X-ray diffraction (XRD) pattern of iron phosphide (Fe₂P) nanorods of size 5 nm (diameter)×88 nm (length) synthesized according to Embodiment 1-A.

FIG. 1-B is an exemplary TEM image of iron phosphide (Fe₂P) nanorods of size 6 nm (diameter)×107 nm (length) synthesized according to Embodiment 1-B.

FIG. 1-C is an exemplary TEM image of iron phosphide (Fe₂P) nanorods of size 6 nm (diameter)×290 nm (length) synthesized according to Embodiment 1-C.

FIG. 1-D is an exemplary TEM image of iron phosphide (Fe₂P) nanorods of size 9 nm (diameter)×50 nm (length) synthesized according to Embodiment 1-D.

FIG. 1-E is an exemplary TEM image of iron phosphide (Fe₂P) nanorods of size 18 nm (diameter)×75 nm (length) synthesized according to Embodiment 1-E.

FIG. 1-F is an exemplary TEM image of iron phosphide (Fe₂P) nanorods of size 5 nm (diameter)×160 nm (length) synthesized according to Embodiment 1-F.

FIG. 2-A is an exemplary TEM image of cobalt phosphide (CO₂P) nanorods of size 5 nm (diameter)×15 nm (length) synthesized according to Embodiment 2.

FIG. 2-B is an exemplary HRTEM image of cobalt phosphide (CO₂P) nanorods of size 5 nm (diameter)×15 nm (length) synthesized according to Embodiment 2.

FIG. 2-C is an exemplary X-ray diffraction (XRD) pattern of cobalt phosphide (CO₂P) nanorods of size 5 nm (diameter)×15 nm (length) synthesized according to Embodiment 2.

FIG. 3-A is an exemplary TEM image of manganese phosphide (MnP) nanorods of size of 5 nm (diameter)×16 nm (length) synthesized according to Embodiment 3.

FIG. 3-B is an exemplary X-ray diffraction (XRD) pattern of manganese phosphide (MnP) nanorods of size of 5 nm (diameter)×16 nm (length) synthesized according to Embodiment 3.

FIG. 4-A is an exemplary TEM image of zinc oxide (ZnO) nanorods of size 8 nm (diameter)×140 nm (length) synthesized according to Embodiment 4.

FIG. 4-B is an exemplary HRTEM image of zinc oxide (ZnO) nanorods of size 8 nm (diameter)×140 nm (length) synthesized according to Embodiment 4.

FIG. 4-C is an exemplary X-ray diffraction (XRD) pattern of zinc oxide (ZnO) nanorods of size of 8 nm (diameter)×140 nm (length) synthesized according to Embodiment 4.

### DISCLOSURE OF THE INVENTION

The primary object of the present invention is, therefore, to disclose novel synthesis methods of producing discrete and uniform-in-diameter nanorods of metals, alloys, metal oxides, metal nitrides, metal pnictides, or metal chalcogenides by reacting continuously injected metal-surfactant complexes using a syringe pump, whereby the resulting 1-D nanorods possess the desirable property of uniformity in diameter and the characteristics in consistency both useful for practical applications.

The present invention discloses the procedures for producing nanorod materials, wherein a syringe pump is employed for continuously injecting metal-surfactant complexes into a hot surfactant solution in order to induce the one-dimensional growth of the desired nanorods.

### DETAILED DESCRIPTION OF THE PRESENT INVENTION

The present invention discloses new and novel methods of synthesizing nanorods of metals, alloys, metal oxides, metal nitrides, metal pnictides, or metal chalcogenides by continuously injecting metal-surfactant complexes into a hot surfactant solution in order to induce the one-dimensional growth of the nanostructured materials, whereby a syringe pump is employed for continuous feeding of metal-surfactant complexes by injection. More specifically, the present invention discloses a method of synthesizing discrete nanorods by reacting metal-surfactant complexes while the metal-surfactant complexes are being continuously injected into a surfactant solution using a syringe pump.

Another aspect of the present invention is to disclose synthetic methods of synthesizing nanorods highly uniform in diameter through the reaction of metal-surfactant complexes injected using a syringe pump. Such high level of uniformity in size in diameter of the nanorods is attributed to form superlattices by self-assembly, thereby the nanorods synthesized according to the present invention have a property of forming superlattices, and such nanorods can be used as a high density magnetic data storage medium at the density level of as high as in the range of terabits/in².

Another object of the present invention is to disclose synthetic methods of controlling the diameter as well as the level of size-uniformity in diameter of the nanorods produced by using a syringe pump for delivering the metal-surfactant complexes at a controlled injection rate.

Another object of the present invention is to disclose synthetic methods of synthesizing nanorods possessing the characteristics, whereby the nanorods maintain a uniform size in diameter and also they do not aggregate even when the nanorods are recovered in a powder form, and also the nanorods can be dispersed many times in various solvents without being aggregated. Such physical properties of non-aggregation and maintaining uniform particle size when the nanorods are recovered according to the present invention, widen the possibility of application areas and the usability of the nanorods suggesting the possibility of potentially recycling as well as reusing.

Yet, another object of the present invention is to disclose synthetic methods of controlling the diameter of the uniformly-formed nanorods by using different stabilizing surfactants.

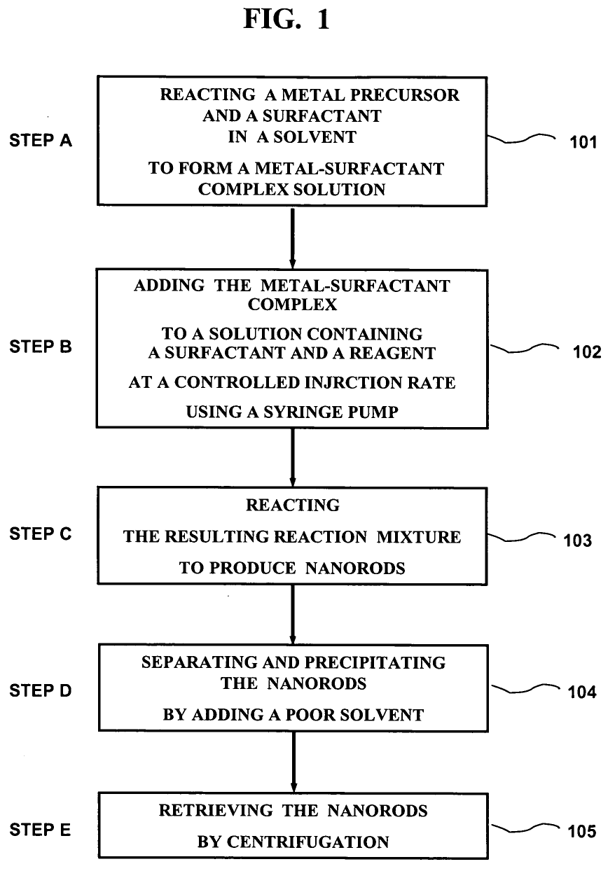

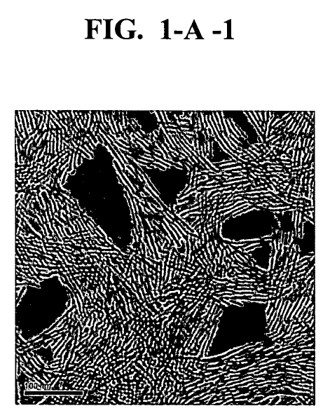

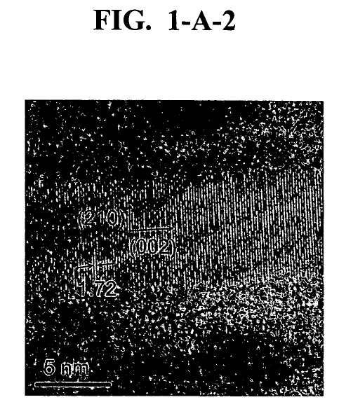

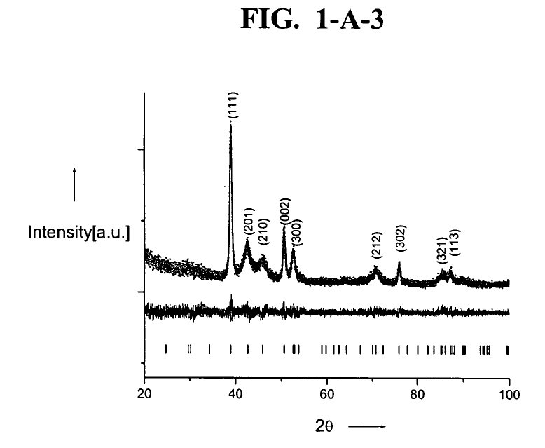

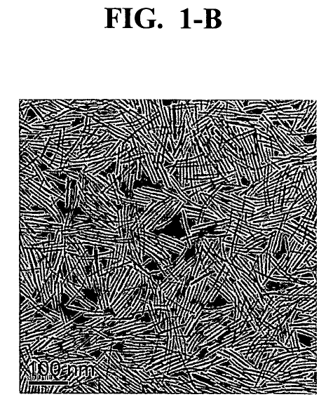

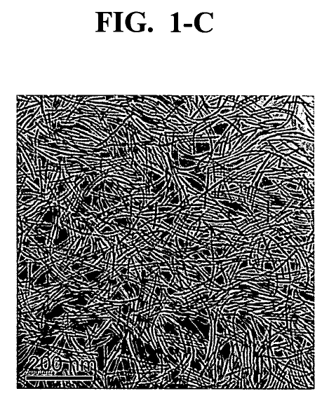

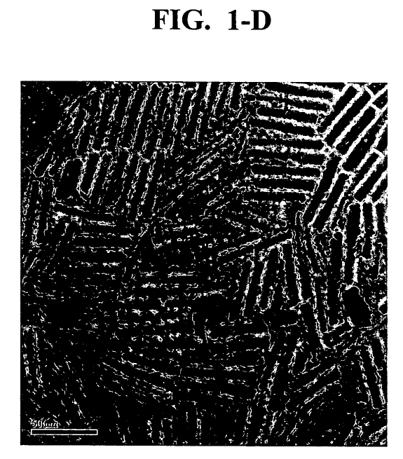

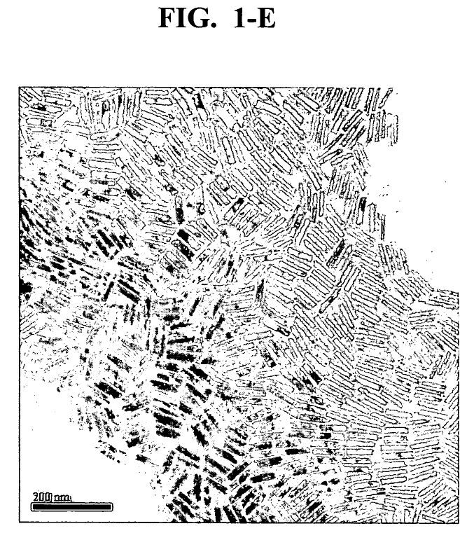

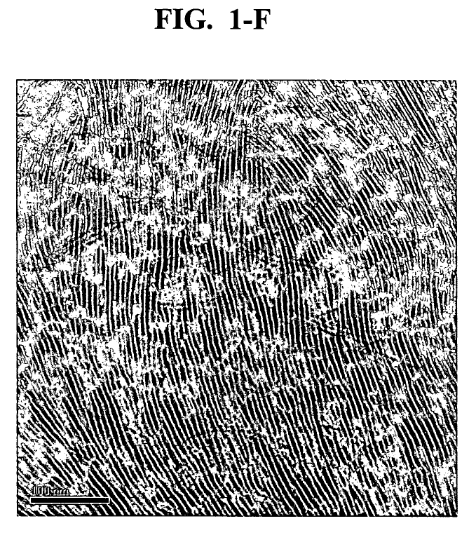

The methods of synthesizing nanorods disclosed here according to the present invention are described below in reference to FIG. 1.

Specifically, according to the present invention and referring to FIG. 1, the desired nanorods are synthesized by the following five steps; Step A 101: A metal-surfactant complex solution is formed by reacting a metal precursor and a surfactant in a solvent. Step B 102: Said metal-surfactant complex solution is injected into a solution containing a surfactant and a reagent in a solvent at a controlled injection rate using a syringe pump to produce a reaction mixture. Step C 103: Nanorods are formed by a process of reaction of said reaction mixture obtained in Step B 102, where the reaction includes thermal decomposition, reduction, oxidation, sulfidation and phosphidation. Step D 104: The desired nanorods are separated and precipitated in the reacted mixture resulted in Step C 103 by adding a poor solvent. Step E 105: The desired nanorods are retrieved from the resulting solution in Step D 104 by centrifuging, thereby the process of synthesizing the desired nanorods is completed.

To be more specific, according to the present invention, referring to FIG. 1, Step A 101, the metal precursors usable for synthesizing the desired nanorods are various organometallic compounds including iron pentacarbonyl [Fe(CO)₅], ferrocene, cobalt tricarbonylnitrosyl [Co(CO)₃(NO)], dicobalt octacarbonyl [CO₂(CO)₈], chromium hexacarbonyl [Cr(CO)₆], nickel tetracarbonyl [Ni(CO)₄] and dimanganese decacarbonyl [Mn₂(CO)₁₀]; metal acetylacetonate compounds including iron acetylacetonate [Fe(acac)₃], cobalt acetylacetonate [Co(acac)₃], barium acetylacetonate [Ba(acac)₂], strontium acetylacetonate [Sr(acac)₂], platinum acetylacetonate [Pt(acac)₂] and palladium acetylacetonate [Pd(acac)₂]; and metal alkoxide compounds including titanium tetraisopropoxide [Ti(ⁱOC₃H₇)₄] and zirconium tetrabutoxide [Zr(OC₄H₉)₄].

According to the present invention, the metals usable as precursors according to the present invention include iron [Fe], cobalt [Co], nickel [Ni], chromium [Cr], manganese [Mn], barium [Ba], strontium [Sr], titanium [Ti], zirconium [Zr], platinum [Pt], palladium [Pd] and the group II through group X transition metals, in particular.

The ligands associated with the precursors include carbonyl [CO], nitrosyl [NO], cyclopentadienyl [C₅H₅], acetate, aromatic compounds and alkoxide family.

According to the present invention, the metal salts usable as precursors are typically iron(III) chloride [FeCl₃], iron(II) chloride [FeCl₂], iron(II) sulfate [FeSO₄], iron(III) nitrate [Fe(NO₃)₃], cobalt(III) chloride [COCl₃], cobalt(II) chloride [COCl₂], cobalt(III) nitrate [Co(NO₃)₃], nickel(II) sulfate [NiSO₄], nickel(II) chloride [NiCl₂], nickel(II) nitrate [Ni(NO₃)₂], titanium tetrachloride [TiCl₄], zirconium tetrachloride [ZrCl₄], hydrogen hexachloroplatinate(IV) [H₂PtCl₆], hydrogen hexachloropalladiate(IV) [H₂PdCl₆], barium chloride [BaCl₂], barium sulfate [BaSO₄], strontium chloride [SrCl₂] and strontium sulfate [SrSO₄], wherein these metal salts consist of various metals including iron [Fe], cobalt [Co], nickel [Ni], chromium [Cr], manganese [Mn], barium [Ba], strontium [Sr], titanium [Ti], zirconium [Zr], platinum [Pt], palladium [Pd] and anions including typically chloride [Cl], nitrate [NO₃], sulfate [SO₄²⁻], phosphate [PO₄³⁻] and alkoxides.

According to the present invention, in order to synthesize the nanorods of alloys and multi-metallic oxides, mixtures of two or more metal precursors listed above can be used as precursors.

According to the present invention, referring to FIG. 1, Step A 101 and Step B 102, the following surfactants can be used for stabilizing the nanorods, where said surfactants include (1) cationic surfactants including typically alkyltrimethylammonium halides such as cetyltrimethylammonium bromide, (2) neutral surfactants including typically oleic acid, trioctylphosphine oxide (TOPO), triphenylphosphine (TPP), trioctylphosphine (TOP) and alkyl amines, RNH₂, where R is alkyl groups with 3-18 carbons, such as oleylamine, octylamine, hexadecylamine, trialkylamine and alkyl thiols, and also (3) anionic surfactants including typically sodium alkyl sulfates and sodium alkyl phosphates. According to the present invention, mixtures of two or more surfactants can also be used.

The solvents used in the present invention are required to have high enough boiling temperature in order to produce the desired nanorods because the metal-surfactant precursors must be decomposed. According to the present invention, referring to FIG. 1, Step A 101, and Step B 102, the usable solvents include typically (1) ethers such as octyl ether, butyl ether, hexyl ether and decyl ether, (2) heterocyclic compounds such as pyridine and tetrahydrofurane (THF), and also (3) aromatic compounds such as toluene, xylene, mesitylene, benzene, dimethyl sulfoxide (DMSO) and dimethylformamide (DMF), and (4) alcohols such as octyl alcohol and decanol, and (5) hydrocarbons such as heptane, octane, decane, dodecane, tetradecane, hexadecane, and also (6) water.

According to the present invention, referring to FIG. 1, Step A 101, during the process of synthesizing nanorods, a metal-surfactant complex is formed at the temperature between 20° C. and 200° C.

According to the present invention, the molar ratio of said metal precursor to said surfactant is maintained between 1:0.1 and 1:1000.

According to the present invention, referring to FIG. 1, Step B 102, the following chalcogenide reagents are used for synthesizing nanorods of metal chalcogenides including elemental sulfur (S₈), selenium (Se), tellurium (Te), trioctylphosphine selenide (TOPSe), trioctylphosphine sulfide (TOPS) and trioctylphosphine telluride (TOPTe).

According to the present invention, referring to FIG. 1, Step B 102, in order to synthesize oxide nanorods, the oxidants including typically oxygen (O₂), hydrogen peroxide (H₂O₂), amine N-oxide such as pyridine N-oxide and trimethylamine N-oxide are used. And also in order to synthesize metal nanorods, according to the present invention, the reductants including typically sodium borohydride (NaBH₄), lithium aluminum hydride (LiAlH₄), lithium triethylborohydride (super-hydride, LiB(C₂H₅)₃H), tetraalkylammonium borohydride (R₄NBH₄) and hydrogen gas are used.

According to the present invention, referring to FIG. 1, Step B 102, said metal-surfactant complexes are injected into a surfactant solution at a temperature between 0° C. and 400° C.

According to the present invention, referring to FIG. 1, Step B 102, said metal-surfactant complexes are injected into a solution using a syringe pump at an injection rate between 1 mL/hr and 100 mL/hr.

According to the present invention, referring to FIG. 1, Step C 103, said reaction process is carried out at a temperature between 0° C. and 400° C.

According to the present invention, referring to FIG. 1, Step C 103, said reaction process of the reaction mixture is carried out for a time duration between 1 minute and 72 hours.

According to the present invention, referring to FIG. 1, Step D 104, said nanorods are separated and precipitated by adding a poor solvent, where the poor solvent is a solvent that does not disperse said nanorods effectively, but induces precipitation of said nanorods readily.

According to the present invention, the desired nanorods are retrieved by centrifuging.

### BEST MODES FOR CARRYING OUT THE PRESENT INVENTION

According to the present invention, the nanorods synthesized by using the method disclosed in the present invention exhibit a narrow size-distribution in diameter and high crystallinity. The embodiments and the corresponding results of the best modes for carrying out the present invention are presented in detail in the following.

### Embodiment 1-A

### Synthesis of Uniform Iron Phosphide (Fe₂P) Nanorods: 1-A

The first exemplary embodiment is to synthesize iron phosphide (Fe₂P) nanorods uniform in diameter according to the present invention disclosed here. A volume of 10 mL of Fe-TOP complex solution prepared by mixing 0.2 mL of iron pentacarbonyl (Fe(CO)₅) or 1.52 mmol and 10 mL of trioctylphosphine (TOP) is injected into a mixture containing 10 mL of octylether and 2 mL of oleylamine at 300° C. using a syringe pump at the injection rate of 10 mL/hr. A TEM (Transmission Electron Microscope) image of the resulting nanorods of iron phosphide (Fe₂P) is shown in FIG. 1-A-1 and exhibits that the resulting iron phosphide (Fe₂P) nanorods have the size of 5 nm (diameter)×88 nm (length) and are uniform in diameter. A HRTEM (High Resolution Transmission Electron Microscope) image shown in FIG. 1-A-2 indicates that the resulting nanorods are highly crystalline, and also that the direction of the growth is along the <002> direction. A corresponding X-ray diffraction (XRD) graph shown in FIG. 1-A-3 reveals that the resulting nanorods have a hexagonal iron phosphide (Fe₂P) crystal structure with the space group P\overline{6}2m.

### Embodiment 1-B

### Synthesis of Uniform Iron Phosphide (Fe₂P) Nanorods: 1-B

Under the same reaction conditions employed in Embodiment 1-A with the exception of the reduced injection rate of the syringe pump at 5 mL/hr, iron phosphide (Fe2P) nanorods are synthesized. An exemplary TEM image of the resultant nanorods shown in FIG. 1-B reveals that the average size is 6 nm (diameter)×107 nm (length) and the diameters are exceptionally uniform.

### Embodiment 1-C

### Synthesis of Uniform Iron Phosphide (Fe₂P) Nanorods: 1-C

Under the same reaction conditions employed in Embodiment 1-A with the exception of the reduced injection rate of the syringe pump at mL/hr, iron phosphide (Fe2P) nanorods are synthesized. An exemplary TEM image of the resultant nanorods shown in FIG. 1-C reveals that the average size is 6 nm (diameter)×290 nm (length) and the sizes in diameter are exceptionally uniform.

### Embodiment 1-D

### Synthesis of Uniform Iron Phosphide (Fe₂P) Nanorods: 1-D

Under the same reaction conditions employed in Embodiment 1-A with the exception of using 2 mL of dioctylamine instead of 2 mL of oleylamine, iron phosphide (Fe₂P) nanorods are synthesized. An exemplary TEM image of the resultant nanorods shown in FIG. 1-D reveals that the average size is 9 nm (diameter)×50 nm (length) and the diameters are exceptionally uniform.

### Embodiment 1-E

### Synthesis of Uniform Iron Phosphide (Fe₂P) Nanorods: 1-E

Under the same reaction conditions employed in Embodiment 1-A with the exception of using 2 mL of octadecylamine instead of 2 mL of oleylamine, iron phosphide (Fe₂P) nanorods are synthesized. An exemplary TEM image of the resultant nanorods shown in FIG. 1-E reveals that the average size is 18 nm (diameter)×75 nm (length) and the diameters are exceptionally uniform.

### Embodiment 1-F

### Synthesis of Uniform Iron Phosphide (Fe₂P) Nanorods: 1-F

Under the same reaction conditions employed in Embodiment 1-A with the exception of using 2 mL of hexadecylamine instead of 2 mL of oleylamine, iron phosphide (Fe₂P) nanorods are synthesized. An exemplary TEM image of the resultant nanorods shown in FIG. 1-F reveals that the average size is 5 nm (diameter)×160 nm (length) and the sizes in diameter are exceptionally uniform.

### Embodiment 2

### Synthesis of Uniform Cobalt Phosphide (CO₂P) Nanorods

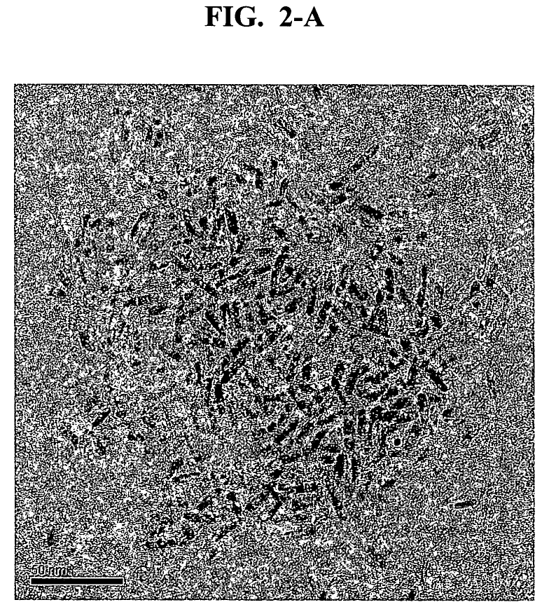

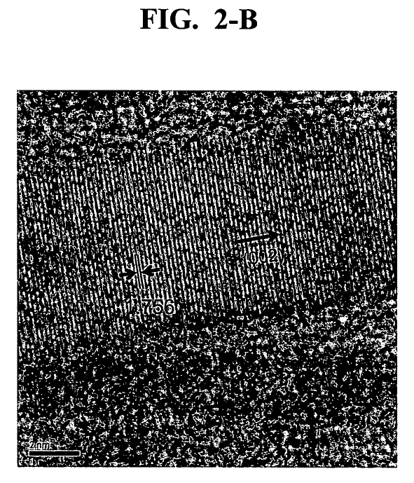

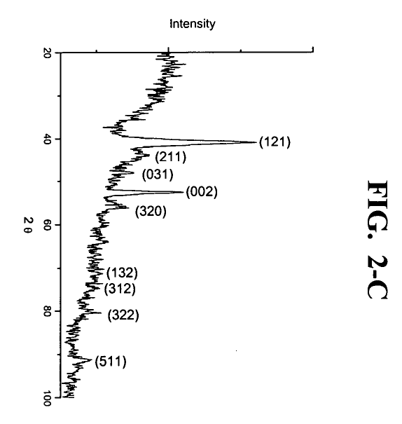

As an exemplary embodiment of synthesizing cobalt phosphide (CO₂P) nanorods uniform in diameter according to the present invention disclosed here, a stock solution is prepared by reacting 0.27 g of Co(acac)₂ and 10 mL of TOP at 70° C. The color of the stock solution changed from pink to violet after complete dissolution of the precursor, indicating that the Co-TOP complex is formed. The stock solution is continuously delivered to the round-bottomed flask containing a mixture of 10 mL of octyl ether and 1.47 g of hexadecylamine at 300° C. through a rubber septum via a syringe pump. The continuous delivery of the stock solution produced a deep black solution in few minutes. The temperature of the resulting solution is maintained at 300° C. for one hour. The resulting cobalt phosphide (CO₂P) nanorods are separated and precipitated by adding 50 mL of ethanol, and retrieved by centrifugation. The collected powdery substance is dispersible in many organic solvents. A TEM image of the resulting cobalt phosphide (CO₂P) nanorods, synthesized by means of the methods disclosed here according to the present invention, is shown in FIG. 2-A. The TEM image reveals that cobalt phosphide (CO₂P) nanorods have an average size of 5 nm (diameter)×15 nm (length). A high resolution TEM (HRTEM) image of the cobalt phosphide (CO₂P) nanorods shown in FIG. 2-B indicates that the nanorods are highly crystalline and that the direction of the growth is in the direction of <002>. An X-ray diffraction (XRD) graph of the resultant cobalt phosphide (CO₂P) nanorods shown in FIG. 2-C reveals that the resulting nanorods have a hexagonal cobalt phosphide (CO₂P) crystal structure.

### Embodiment 3

### Synthesis of Uniform Manganese Phosphide (MnP) Nanorods

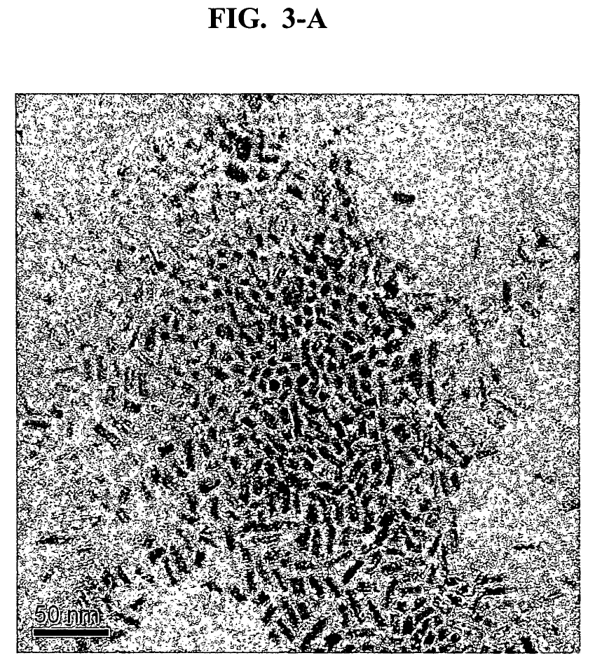

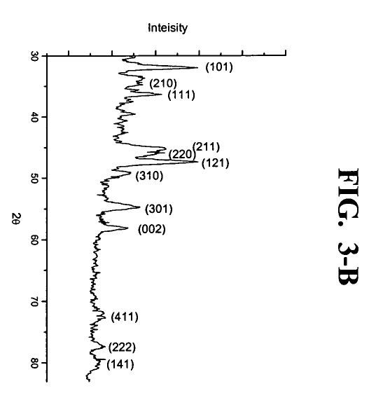

As an exemplary embodiment of synthesizing manganese phosphide (MnP) nanorods uniform in diameter according to the present invention, a stock solution is prepared by mixing 0.148 g of Mn₂(CO)₁₀ or 0.38 mmol and 5 mL of trioctylphosphine (TOP) at 70° C. This stock solution is continuously injected into the 5 g of trioctylphosphine oxide (TOPO) solution while being vigorously stirred at 330° C. using a syringe pump at the injection rate of 10 mL/hr. The temperature of the resulting solution is maintained at 330° C. for one hour, and thereafter cooled down to 60° C. By adding 50 mL of anhydrous ethanol (or acetone) to the resulting solution, the nanorods in the state of flocculation are formed. By centrifugation, the flocculates are separated and retrieved from the supernatant. These flocculates are washed two times with 50 mL of ethanol to remove excess TOP and TOPO. The resultant precipitate is dried under vacuum, and a substance in a powder form is obtained. The resulting powdery manganese phosphide nanorods (MnP) are found to be readily dispersible in organic solvents such as hexane, toluene or chloroform. A TEM image of the resulting manganese phosphide (MnP) nanorods, synthesized by means of the methods disclosed here according to the present invention, is as shown in FIG. 3-A, exhibiting that the resulting manganese phosphide (MnP) nanorods have an average size of 5 nm (diameter)×16 nm (length). An X-ray diffraction (XRD) graph shown in FIG. 3-B reveals that the resulting manganese phosphide (MnP) nanorods have a hexagonal manganese phosphide (MnP) structure.

### Embodiment 4

### Synthesis of Uniform Zinc Oxide (ZnO) Nanorods

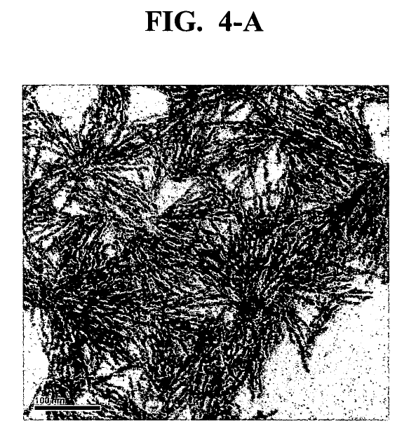

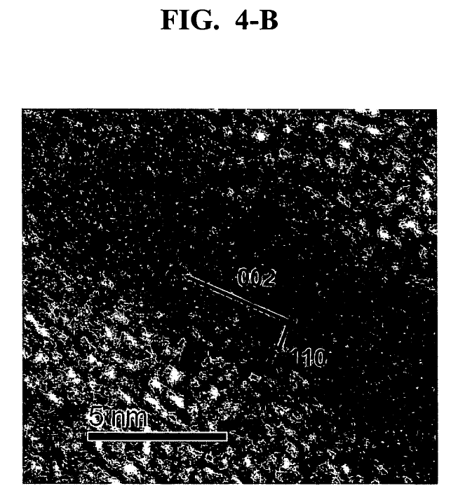

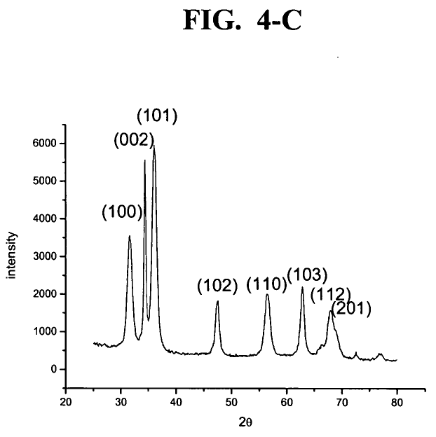

As an exemplary embodiment of synthesizing zinc oxide (ZnO) nanorods uniform in diameter according to the present invention disclosed here, 5 g of trioctylphosphine oxide (TOPO) is heated to 330° C. as the first preparation step. A stock solution is prepared by mixing 0.5 g of Zn(OAc)₂.2H₂₀ or 2.27 mmol and 2 mL of anhydrous ethanol in the presence of 10 mL of trioctylphosphine (TOP) pre-heated to 80° C. under a nitrogen atmosphere. By using a syringe pump, this stock solution is injected at the rate of 10 mL/hr into the TOPO solution already pre-heated to 330° C. After the injection, the temperature of the resulting reaction mixture is maintained at 330° C. for one hour. After the reaction, the resulting mixture is cooled to 50° C. and then poured into methanol, producing a white precipitate. The resulting precipitate is isolated by centrifugation and washed twice with methanol, resulting in a white powdery substance or zinc oxide (ZnO) nanorods which are easily re-dispersed in toluene or cyclohexane. A TEM image of the resulting zinc oxide (ZnO) nanorods, synthesized by means of the methods presented here according to the present invention, is as shown in FIG. 4-A. The TEM image indicates that the synthesized zinc oxide (ZnO) nanorods have a size of 8 nm (diameter)×140 nm (length). A HRTEM image shown in FIG. 4-B reveals that the resulting zinc oxide (ZnO) nanorods are highly crystalline and that the direction of the growth is along the <002> direction. An X-ray diffraction (XRD) graph of the resultant zinc oxide (ZnO) nanorods is shown in FIG. 4-C, indicating that the nanorods have a hexagonal zinc oxide (ZnO) structure.

The procedures and results presented here are merely illustrative examples of carrying out the implementation of the underlying ideas and procedures of the present invention, and the exemplary embodiments given above are neither intended for exhaustively illustrating the basic ideas and procedures nor limiting the scope of the present invention. Furthermore, those who are familiar with the art related to the present invention should be able to easily derive variations and modifications of the underlying ideas and procedures of the present invention disclosed here.

### INDUSTRIAL APPLICABILITY

Uniform and highly crystalline nanorods synthesized according to the present invention display very unique, excellent and consistent electrical, magnetic as well as optical properties. In particular, the optical property due to excellent uniformity in diameter demonstrated by the nanorods produced by the synthetic method disclosed by the present invention is very attractive for such applications as display devices and biological labeling. Excellent uniformity in diameter of the magnetic nanorods synthesized according to the present invention is also attractive particularly for the applications in the area of the ultra-high density magnetic storage media.

1. A method of synthesizing uniform nanorods of metals, alloys, metal oxides, metal nitrides, metal pnictides, and metal chalcogenides, comprising the steps of;
reacting a metal precursor and a surfactant in a solvent to form a metal-surfactant complex solution;
injecting said metal-surfactant complex into a solution containing a surfactant and a reagent at high temperature using a syringe pump at a constant injection rate to form a reaction mixture;
reacting said reaction mixture to form said nanorods;
separating and precipitating said nanorods in the reacted mixture by adding a poor solvent; and
retrieving said nanorods by centrifuging.

2. The method of claim 1, wherein said metal precursor is selected from a group of (a) organometallic compounds including typically iron pentacarbonyl [Fe(CO)₅], ferrocene, cobalt tricarbonylnitrosyl [Co(CO)₃(NO)], dicobalt octacarbonyl [CO₂(CO)₈], chromium hexacarbonyl [Cr(CO)₆], nickel tetracarbonyl [Ni(CO)₄] and dimanganese decacarbonyl [Mn₂(CO)₁₀], (b) metal acetylacetonate compounds including typically iron acetylacetonate [Fe(acac)₃], cobalt acetylacetonate [Co(acac)₃], barium acetylacetonate [Ba(acac)₂], strontium acetylacetonate [Sr(acac)₂], platinum acetylacetonate [Pt(acac)₂] and palladium acetylacetonate [Pd(acac)₂], and (c) metal alkoxide compounds including typically titanium tetraisopropoxide [Ti(ⁱOC₃H₇)₄] and zirconium tetrabutoxide [Zr(OC₄H₉)₄].

3. The method of claim 1, wherein said metals used for the precursors are selected from typically iron [Fe], cobalt [Co], nickel [Ni], chromium [Cr], manganese [Mn], barium [Ba], strontium [Sr], titanium [Ti], zirconium [Zr], platinum [Pt], palladium [Pd] and the groups 11 through X transition metals in particular.

4. The method of claim 1, wherein the ligands associated with said precursors are typically carbonyl [CO], nitrosyl [NO], cyclopentadienyl [C₅H₅], acetate, aromatic compounds and alkoxide family.

5. The method of claim 1, wherein said metal salts used as precursors are typically iron(III) chloride [FeCl₃], iron(II) chloride [FeCl₂], iron(II) sulfate [FeSO₄], iron(III) nitrate [Fe(NO₃)₃], cobalt(III) chloride [COCl₃], cobalt(II) chloride [COCl₂], cobalt(III) nitrate [Co(NO₃)₃], nickel(II) sulfate [NiSO₄], nickel(II) chloride [NiCl₂], nickel(II) nitrate [Ni(NO₃)₂], titanium tetrachloride [TiCl₄], zirconium tetrachloride [ZrCl₄], hydrogen hexachloroplatinate(IV) [H₂PtCl₆], hydrogen hexachloropalladiate(IV) [H₂PdCl₆], barium chloride [BaCl₂], barium sulfate [BaSO₄], strontium chloride [SrCl₂] and strontium sulfate [SrSO₄], whereby these metal salts consist of various metals including typically iron [Fe], cobalt [Co], nickel [Ni], chromium [Cr], manganese [Mn], barium [Ba], strontium [Sr], titanium [Ti], zirconium [Zr], platinum [Pt], palladium [Pd], and anions including typically chloride [Cl⁻], nitrate [NO₃⁻], sulfate [SO₄²⁻], phosphate [PO₄³⁻] and alkoxides.

6. The method of claim 1, wherein said nanorods of alloys and multi-metallic oxides are formed using mixtures of two or more metal precursors selected from the list in claim 2 instead of using a metal precursor.

7. The methods of claim 1, wherein said surfactant is selected from (a) cationic surfactants including typically alkyltrimethylammonium halides such as cetyltrimethylammonium bromide, (b) neutral surfactants including typically oleic acid, trioctylphosphine oxide (TOPO), triphenylphosphine (TPP), and trioctylphosphine (TOP), alkyl amines, RNH₂, where R is alkyl groups with 3-18 carbons, such as oleylamine, octylamine, and hexadecylamine, and trialkylamine and alkyl thiols, and (c) anionic surfactants including typically sodium alkyl sulfates and sodium alkyl phosphates, and mixtures of two or more surfactants listed above.

8. The methods of claim 1, wherein said solvent is selected from typically (a) ethers such as octyl ether, butyl ether, hexyl ether and decyl ether, (b) heterocyclic compounds such as pyridine and tetrahydrofurane (THF), (c) aromatic compounds such as toluene, xylene, mesitylene, benzene, (d) dimethyl sulfoxide (DMSO) and dimethylformamide (DMF), (e) alcohols such as octyl alcohol and decanol, (f) hydrocarbons such as heptane, octane, decane, dodecane, tetradecane and hexadecane, and also (g) water.

9. The method of claim 1, wherein said metal-surfactant complex is formed at a temperature between 20° C. and 200° C.

10. The method of claim 1, wherein the molar ratio of said metal precursor to said surfactant is in the range between 1:0.1 and 1:100.

11. The method of claim 1, wherein for synthesizing nanorods of metal chalcogenides said reagent is selected typically from elemental sulfur (S₈), selenium (Se), tellurium (Te), trioctylphosphine selenide (TOPSe), trioctylphosphine sulfide (TOPS) and trioctylphosphine telluride (TOPTe).

12. The method of claim 1, wherein for synthesizing nanorods of metal oxides said oxidant is selected typically from oxygen (O₂), hydrogen peroxide (H₂O₂), and amine N-oxide such as pyridine N-oxide and trimethylamine N-oxide.

13. The method of claim 1, wherein for synthesizing metal nanorods said reductant is selected typically from sodium borohydride (NaBH₄), lithium aluminum hydride (LiAlH₄), lithium triethylborohydride (super-hydride, LiB(C₂H₅)₃H), tetramethylammonium borohydride ((CH₃)₄NBH₄) and hydrogen gas.

14. The method of claim 1, wherein said metal-surfactant complexes are injected into a solution at a temperature between 0° C. and 400° C.

15. The method of claim 1, wherein said metal-surfactant complexe is injected into a solution using a syringe pump at an injection rate between 1 mL/hr and 100 mL/hr.

16. The method of claim 1, wherein said reaction process of said reaction mixture is carried out at a temperature between 0° C. and 400° C.

17. The method of claim 1, wherein said reaction process of the reaction mixture is carried out for a time period between 1 minute and 72 hours.
